(19) United States
(12) Patent Application Publication
(10) Pub. No.: US 2006/0289607 A1
(43) Pub. Date: Dec. 28, 2006

(54) Composite solder transfer moldplate structure and method of making same

(76) Inventors: Stephen L. Buchwalter, Hopewell Junction, NY (US); David Danovitch, Canton-de-Granby (CA); Frank D. Egitto, Binghamton, NY (US); Peter A. Gruber, Mohegan Lake, NY (US); Eric D. Perfecto, Poughkeepsie, NY (US); Da-Yuan Shih, Poughkeepsie, NY (US)

Correspondence Address: David Aker, 23 Southern Road, Hartsdale, NY, 10530, US

(21) Appl. No.: 11/168,182

(22) Filed: Jun. 28, 2005

(51) Int. Cl. B23K 35/12

(52) U.S. Cl. 228/39

(57) ABSTRACT

A method for constructing a composite solder transfer moldplate for flip chip wafer bumping of a substrate, comprising the steps of coating at least one polymer layer onto a first side of a transparent plate, the plate having a thermal expansion coefficient similar to that of the substrate; and forming a multiplicity of cavities in a polymer layer on one side of the plate, each cavity being for receiving solder. A moldplate made by the method. The structure has required behavior through temperature excursions between room temperature and various solder molten temperatures.

### FIELD OF THE INVENTION

The present invention relates to a method for providing moldplates used in flip chip wafer bumping, and to moldplates produced by the method. More particularly, it relates to a method for building composite moldplates by coating substrate plates, and machining these coated layers, and to the moldplates produced.

### BACKGROUND OF THE INVENTION

As seen in FIG. 1, previously solder transfer moldplates had blind holes or cavities placed directly within the glass that typically comprised such structures. Since electronic wafers are usually made of silicon, the glass used to transfer the solder deposited by injection molded solder (IMS) is carefully chosen to closely match the coefficient of thermal expansion (CTE) of silicon (2.3 10⁻⁶/degree C.). Borosilicate glass provides such a CTE match and has several additional desirable attributes. Included in these is the ability to chemically etch cavities in the glass and transparency for optical alignment between solder filled cavities and pads which will receive the solder on a silicon wafer. However, there are also significant challenges to producing borosilicate glass solder transfer moldplates.

U.S. Pat. No. 6,332,569 entitled “Etched Glass Solder Bump Transfer for Flip Chip Integrated Circuit Devices” details the multiple steps involved in producing uniform cavities directly in glass. Especially as the number of cavities increase and the cavity dimensions decrease, several of the key processing steps are prone to defects that affect the completed moldplate quality. Photolithographic tooling is required for typically fine cavity dimensions involving costly masks to define the initial locations of cavities that will be chemically etched. Processing usually involves these steps:
1. coating glass plate with several metal layers to provide adhesion and glass etch masking
2. coating metal layers with photoresist
3. patterning the photoresist with mask
4. etching the metal layers according to the photoresist pattern
5. removing the photoresist
6. isotropically etching the glass according to the metal layer pattern
7. removing the metal layers by etching.

These multiple steps proceed in sequential fashion. Thus, if there is a defect with any of the processing steps, the part must be either reworked or discarded. More processing steps increase the risk of such defects and affect the overall yield of the process.

The continuing increase of circuit densities has caused a commensurate increase in input/output (I/O) count. Numbers have risen to hundreds for memory and many thousands for processor dies. Thus, both the cavity size and pitch required decrease in order to accommodate these increasing numbers. All these requirements increase the challenge of making defect free moldplates with the conventional process.

### SUMMARY OF THE INVENTION

It is therefore an aspect of the present invention to provide a moldplate that is made by a simple and inexpensive process, is robust and is easily produced.

It is a further object of the invention to provide a method for inexpensively and reliably producing moldplates.

The present invention provides a method for making a composite solder transfer moldplate structure with a substantially simplified procedure over the conventional process. Thus, it reduces the complexity and also the cost for making such moldplates. Since IMS wafer bumping is mainly designed to reduce overall bumping costs and moldplates are a key aspect of the technology, reducing the cost of such is an important requirement.

For example, in comparison to the multiple steps listed above for the conventional method,, the simplest and preferred embodiment to produce the structure seen in FIG. 2 involves the following steps:
1. laminating a polymer sheet on a glass plate; and
2. laser drilling cavities through the polymer sheet on one side according to a programmed design

The reduction in processing steps is readily apparent. Although other embodiments are described, this preferred embodiment will work for many applications. Since the laminated layers are transparent, the overall usage of this new moldplate structure is similar to a conventionally etched one. Thus, filling, inspecting and transferring the solder to wafers happens in much the same manner as before.

Thus the present invention results in a reduction in processing steps to produce the solder receiving cavities in this new composite solder transfer moldplate structure. At the same time, the desirable attributes of glass solder transfer moldplates remain for the new composite structure. For example, the overall structure remains optically transparent for proper optical alignment. Also, the previous CTE matching properties also exist in the new composite structure, since the core of the composite also may be borosilicate glass.

Thus the invention is directed to a method for constructing a composite solder transfer moldplate for flip chip wafer bumping of a substrate, comprising the steps of coating at least one polymer layer onto a first side of a transparent plate, the plate having a thermal expansion coefficient similar to that of the substrate; and forming a multiplicity of cavities in a polymer layer on one side of the plate, each cavity being for receiving solder. The polymer may be a polyimide. The plate may be formed of a glass. It is preferable that the coating does not cause significant changes in flatness of the plate.

An additional polymer layer may be applied onto the plate on a side of the plate opposite the first side. Coating may be performed by at least one of spin coating and lamination. Lamination may comprises a micro-roughening of the surface of the plate to enhance adhesion of the polymer layer to the plate. The lamination may include applying a liquid polymer between the plate and each polyimide layer to increase bond strength between the layer and the plate.

The method may further comprise passivating the polymer layer containing the multiplicity of cavities with a metal layer. The metal layer may be composed of a single layer selected from Cr, Mo, W, V, Ti, Nb, Hf, Cu, Ni, Co, and alloys thereof. The metal layer may be composed of a multilayer coating wherein metals of two adjacent layers are selected from two or more of Cr, Mo, W, V, Ti, Nb, Hf, Cu, Ni, Co.

Preferably, the cavities in one of the polyimide layers are formed by laser machining, and in particular maskless programmable laser machining. The laser machining may be performed by using a Nd:YAG laser operating at a wavelength of 355 nanometers, at a power of 0.4 watts. Preferably, the output of the laser used for laser machining is focused below a surface of the polymer layer, and is provided as a series of 50 nanosecond pulses, at a repetition rate of substantially 10 kHz.

The invention is also directed to a moldplate structure having at least one polymer layer disposed on at least one side of a transparent plate. A multiplicity of cavities is formed in the polymer layer for receiving solder. The plate may be formed of a glass. Preferably, the glass has a coefficient of thermal expansion matched to that of silicon, and may be one of a borosilicate or Pyrex™.

The plate may comprise at least one polymer layer on each side of the plate. At least one polymer layer may comprise a polyimide. At least one polymer layer may have a thickness of between substantially 0.13 mm and substantially 0.25 mmm.

A metal layer may be disposed on the polymer layer. The metal layer may be composed of a single layer selected from Cr, Mo, W, V, Ti, Nb, Hf, Cu, Ni, Co, and alloys thereof. The metal layer may be composed of a multilayer coating wherein metals of two adjacent layers are selected from two or more of Cr, Mo, W, V, Ti, Nb, Hf, Cu, Ni, Co.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is an enlarged, cross-sectional view of a prior art moldplate made by etching cavities directly into a glass substrate.

FIG. 2 is an enlarged, cross-sectional view of a composite solder transfer moldplate structure having a top and bottom polyimide coating on a glass plate, in accordance with the invention.

FIG. 3 illustrates a problem with bowing that occurs if a glass plate is coated with a polyimide layer on only one side and the plate is subjected to thermal excursions.

FIG. 4 shows how bowing is eliminated if the plate is coated on both top and bottom sides with polyimide layers to balance the thermal stress between room temp and elevated temps.

FIG. 5 illustrates the beginning of a process of making a composite solder transfer moldplate structure, starting with a blank glass plate, in accordance with the invention.

FIG. 6 illustrates the step of coating the bottom and top sides of the glass plate with the polyimide layers.

FIG. 7 illustrates the composite solder transfer moldplate structure before the laser machining step to produce cavities.

FIG. 8 illustrates the composite solder transfer moldplate structure after the laser machining step used to produce the cavities.

FIG. 9 begins the process of using the composite solder transfer moldplate structure to bump silicon wafers; that is to heat the composite solder transfer moldplate structure above the melting temperature of the solder.

FIG. 10 illustrates the composite solder transfer moldplate structure after having been scanned by an IMS head to fill the cavities with molten solder and then solidifying the same by removing it from the heat source.

FIG. 11 illustrates the composite solder transfer moldplate structure aligned to the solder receiving pads on a silicon wafer and then reheated above the solder molten temperature.

FIG. 12 illustrates the separating of the composite solder transfer moldplate structure from the silicon wafer after the assembly has been cooled below the solder molten temperature, leaving the solder from the cavities transferred to the wafer.

FIG. 13 illustrates a further enlarged cross section of the composite solder transfer moldplate structure with a metal passivation layer over the top of the polyimide surface, in accordance with an additional embodiment of the invention.

FIG. 14A, 14B and 14C illustrates a fiducial alignment scheme for the embodiment of FIG. 13, that allows moldplate and wafer to be aligned without the moldplate being transparent by having alignment windows in the moldplate and corresponding marks on the wafer.

FIG. 15 illustrates the geometry and an equation used to determine a cavity profile made by programmable laser machining.

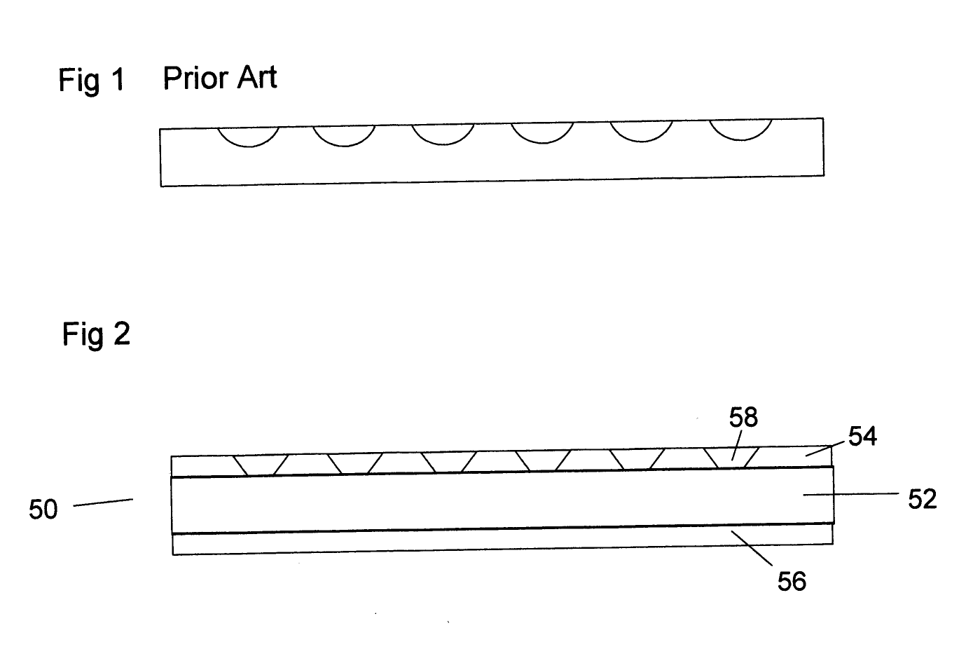

### DESCRIPTION OF THE INVENTION

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

Referring to FIG. 2, the elements of the composite solder transfer moldplate 50 include a glass plate 52 which is CTE matched to silicon, a top polyimide layer 54 and a bottom polyimide layer 56, with cavities 58 in the top layer.

It is noted that while a polyimide is presently preferred, there are other polymers that are acceptable. A polymer is acceptable if it has the required thermal resistance (that is it can maintain its integrity throughout the required temperature range), toughness and chemical resistance.

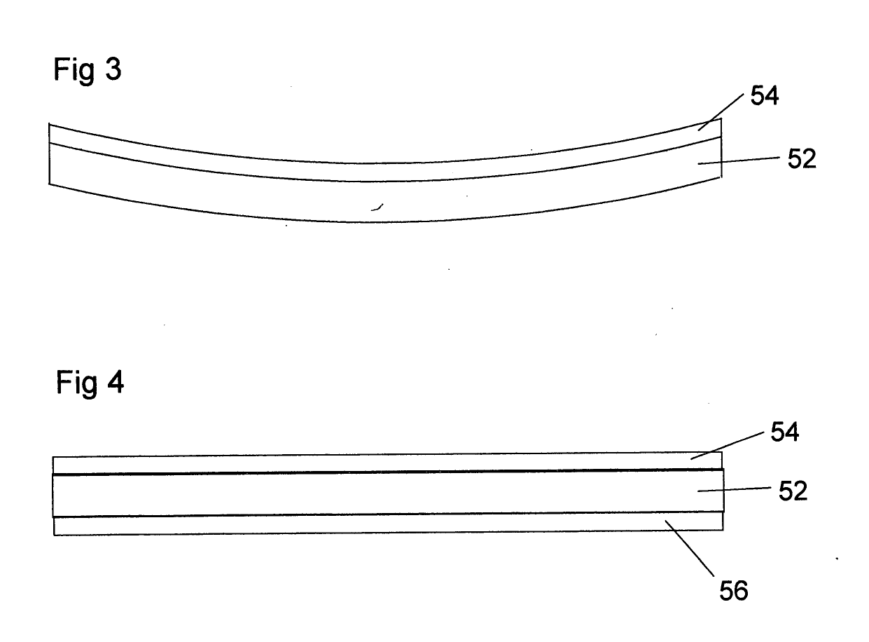

The problems of CTE mismatch between the polyimide sheets and borosilicate glass is illustrated in FIG. 3. With only one side of the glass plate 52 coated with polyimide layer 54, at higher temperatures, bowing will occur as the higher CTE of the polyimide layer 54 results in forces that act on the four corners of the glass plate 52. This interferes both with solder filling of the cavities 58 by IMS as well as transfer of the solder to a silicon wafer, since the moldplate 50 needs to be relatively flat for both operations.

FIG. 4 illustrates a novel double lamination, where the core glass plate 52 has both a top polyimide layer 54 and a bottom polyimide layer 56. This prevents bowing by equalizing the forces due to CTE mismatch on each side of the glass plate 52 resulting in no net stresses during thermal excursions and maintaining a flat profile during fill and transfer operations. For this CTE mismatch cancellation feature to work properly, it is necessary for the thicknesses of both top and bottom sheets to be equal (assuming that the same material is used for both the top and bottom layers).

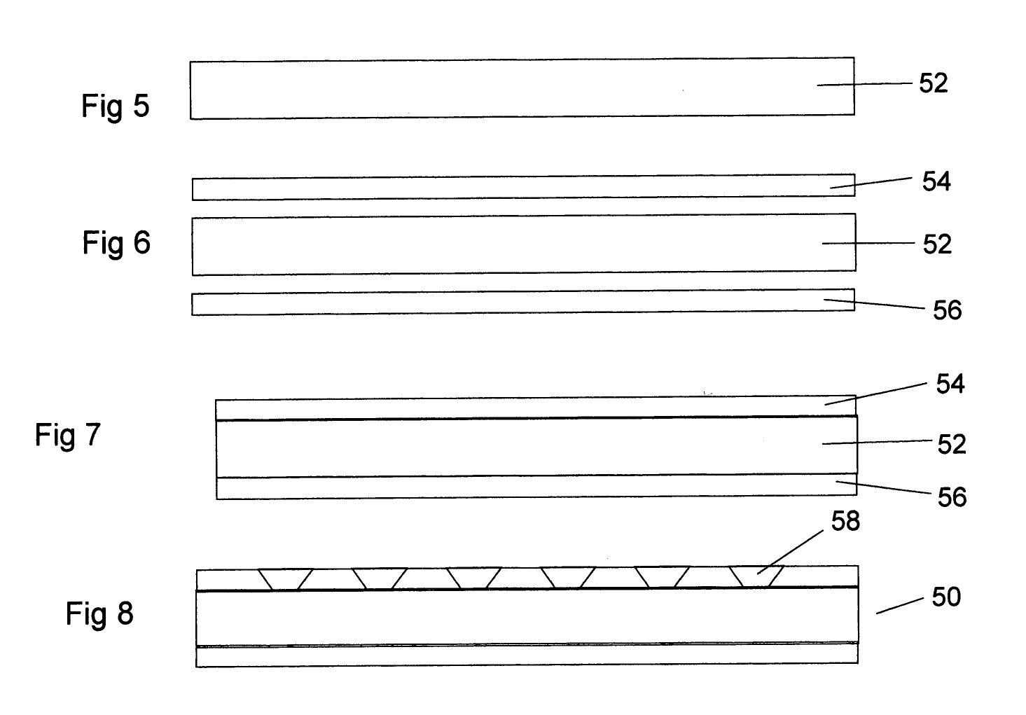

FIG. 5 to FIG. 8 detail the steps involved in producing the new composite solder transfer moldplate structure. FIG. 5 shows a glass plate 52 that is CTE matched to silicon. The glass used for this can be borosilicate or Pyrex™ or any other glass with a CTE similar to that of silicon. FIG. 6 shows the two layers of polyimide, 54 and 56 respectively, to be laminated to the glass plate 52, one on each side. It may be desirable to slightly roughen the glass surface (scale of a few micro-inches) to enhance adhesion of the laminated sheets. A liquid polyimide adhesive material such as the XP3000 series, synthesized from aromatic dianhydrides and/or diamines to create a high molecular weight precurser, and an intractable polyimide film when cured, made by HD Microsystems, of Parlin, N.J., may be used to enhance the bond strength of the resulting lamination.

Since the sheet thickness is one determiner of solder volumes for the cavities, uniformity is very important. This is because the subsequent programmable laser machining process typically drills holes all the way through from top to the bottom of the top polyimide layer 54. Commercially available polyimide sheets have excellent thickness uniformities which compliment the required layer uniformity of the composite moldplate structures. Overall sheet thicknesses range from 0.5-10 thousandths of an inch (0.013 mm to 0.25 mm), with typical sheet thicknesses ranging between 1-5 thousandths of an inch (0.025 mm to 0.13 mm). Sheet materials may be chosen from several commercially available polyimides such as Kapton™, Apical™ or Upilex™, with the latter having the lowest CTE (and therefore the most compatible for this application, but being of somewhat higher cost). Although lamination of sheets is the preferred embodiment, other processes such as spin-coating of polyimide are also possible.

FIG. 7 thus shows the composite structure consisting of top polyimide layer 54, glass plate 52 and bottom polyimide layer 56 after the lamination is complete.

At this point the composite structure is ready for the laser machining step. FIG. 8 shows the composite structure of the moldplate 50 after the machining step that produces the cavities 58. The preferred technique is programmable laser drilling. Rather than using a transmission laser mask, a programmable laser process entirely avoids the need for a mask.

Thus, various designs can be quickly produced as a composite solder transfer moldplate structure simply by using a data file for generating control inputs for the laser system corresponding to each wafer footprint.

Unlike cavities etched in glass, holes in the polyimide typically go all the way through the top layer. Volumes required for certain solder ball dimensions determine the thickness of the top (and bottom) layer. Since wall angles produced by laser processing can be controlled by adjustment of laser drilling parameters, as is well known in the art, this information, in conjunction with the distance between cavities, is used in determining sheet thickness. The example below lists specific laser drilling parameters used to produce a composite solder transfer moldplate structure.

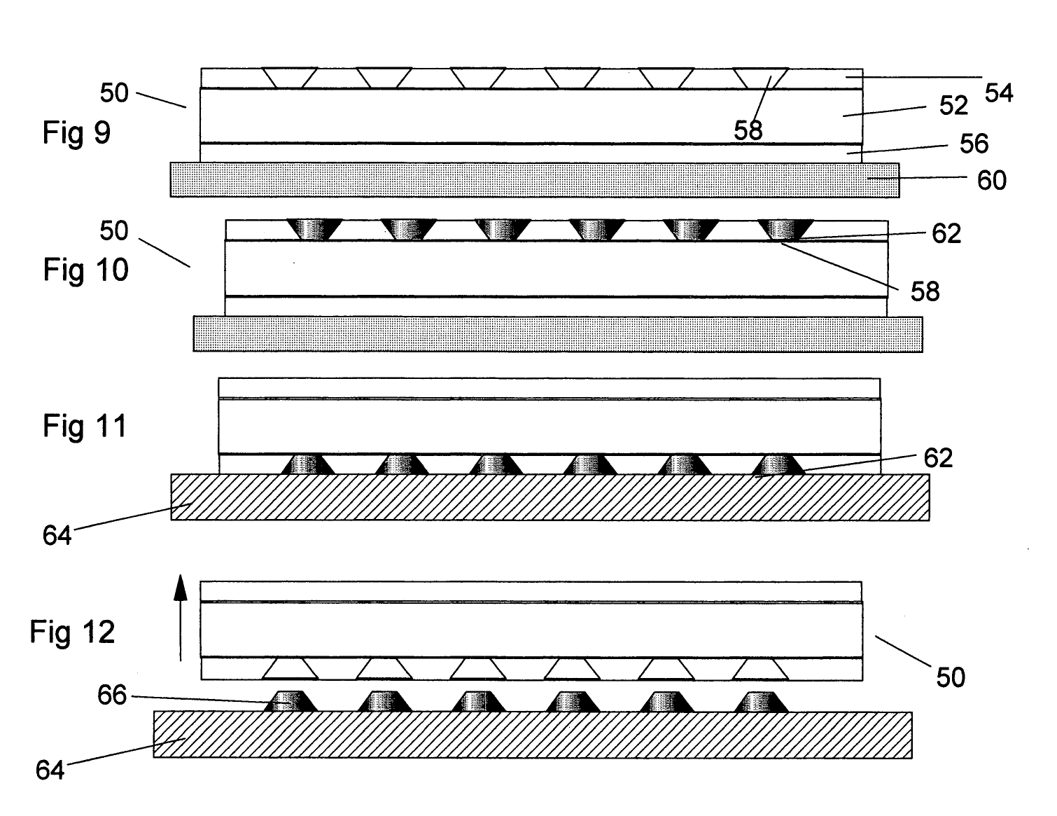

FIG. 9 to FIG. 12 detail the use of the new composite solder transfer moldplate structure to bump wafers to produce IC's used in flip chip packaging. FIG. 9 shows the composite structure 50 before the cavities 58 are filled with solder by IMS. At this point, the structure 50 is placed on a heater 60 to bring it at or near the molten temperature of the solder so that when the plate is scanned by the IMS head (not shown), the solder will dispense into the moldplate cavities 58 while molten and remain so while the IMS head wiper removes excess material from each successive row of cavities. Also, the fill operation is best performed in a low oxygen environment to prevent excessive oxidation of the solder in the filled rows. Typically, a low oxygen environment is provided by flushing the volume within the fill area of the IMS tool with nitrogen gas.

FIG. 10 shows the cavities with the solder fill. At this point the composite solder transfer moldplate structure is removed from the heat source 60 so as to solidify the solder volumes 62 in the cavities 58. Once the solder has solidified, it may be removed from the nitrogen environment. Another key desirable feature of this invention is the contrast between the solder filled cavities and the rest of the polyimide layer. Significant optical contrast between solder filled cavities and the surrounding darker, less reflective polyimide layer enhances the ease with which fill inspection and transfer plate alignment to silicon wafer are accomplished.

FIG. 11 shows the vertically flipped composite solder transfer moldplate structure with solder filled cavities 62 aligned to and placed in contact with the pads on the silicon wafer 64 to be bumped. U.S. Pat. No. 6,003,757 entitled “Apparatus for Transferring Solder Bumps and Method of Using” describes how the aligned and mated assembly is maintained during the solder reflow process which transfers the solder to the wafer.

Finally, FIG. 12 shows the lifting off of the new transfer structure 50 from the solder bumped silicon wafer 64 leaving solder volumes, now designated with a different reference numeral 66, due to being disposed on the wafer 64. The now empty composite solder transfer moldplate 50 is ready to be refilled with solder for the next bumping operation.

The previously described steps are especially well suited for various fluxless reflow processes that are available, such as hydrogen reflow or formic acid reflow, as described in U.S. Pat. No. 5,604,831. When a fluxless reflow process is used, flux cleaning steps are avoided thus preventing any aggressive solvents from affecting the polyimide. However, fluxes and solvents are available which will have little or no adverse effect on the polyimide layers. For aggressive solvents, another embodiment of the composite moldplate structure is available.

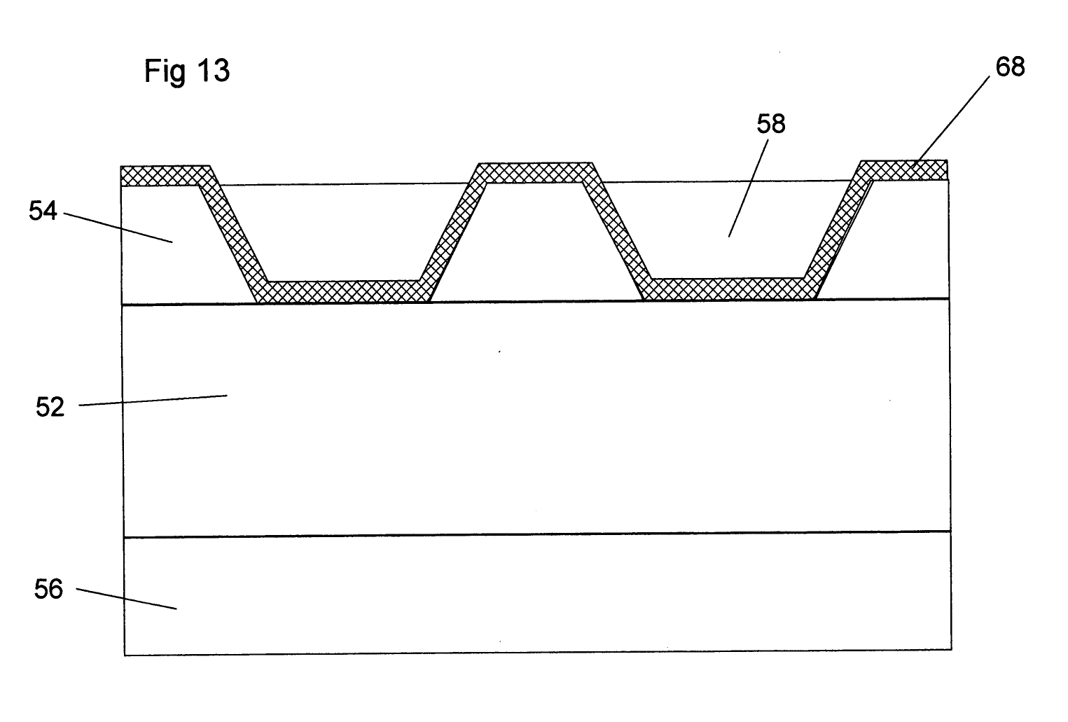

FIG. 13 shows one alternate embodiment of the moldplate 50A configured to further enhance the robustness of the polyimide mold layer against chemical attack, such as attack by certain solvents used to clean solder flux. In this case the polyimide layer 54 containing the cavities 58 is conformally coated with a layer of metal 68 that is selected so as to adhere well to the planar top polyimide surface, as well as to the side wall of the cavity, to prevent it from reacting with solder, solder flux or other chemical agents. A process that provides such a conformal type coating is sputter deposition. In this way, even the side walls of the cavities with their angled faces are properly coated and passivated.

Candidates for this metal layer include, but are not limited to Cr, Mo, W, V, Ti, Nb, Hf, Cu, Ni, Co. These layers can be deposited as either a single or multilayer coating, depending on the passivation requirements. The surface of the passivation metal is also again deliberately passivated by oxidization to provide a non-wetting and non-reactive surface for the molten solder. When such a metal passivation layer is used over the polyimide, other methods of alignment such as split optics must be used since the composite solder transfer moldplate structure is no longer transparent.

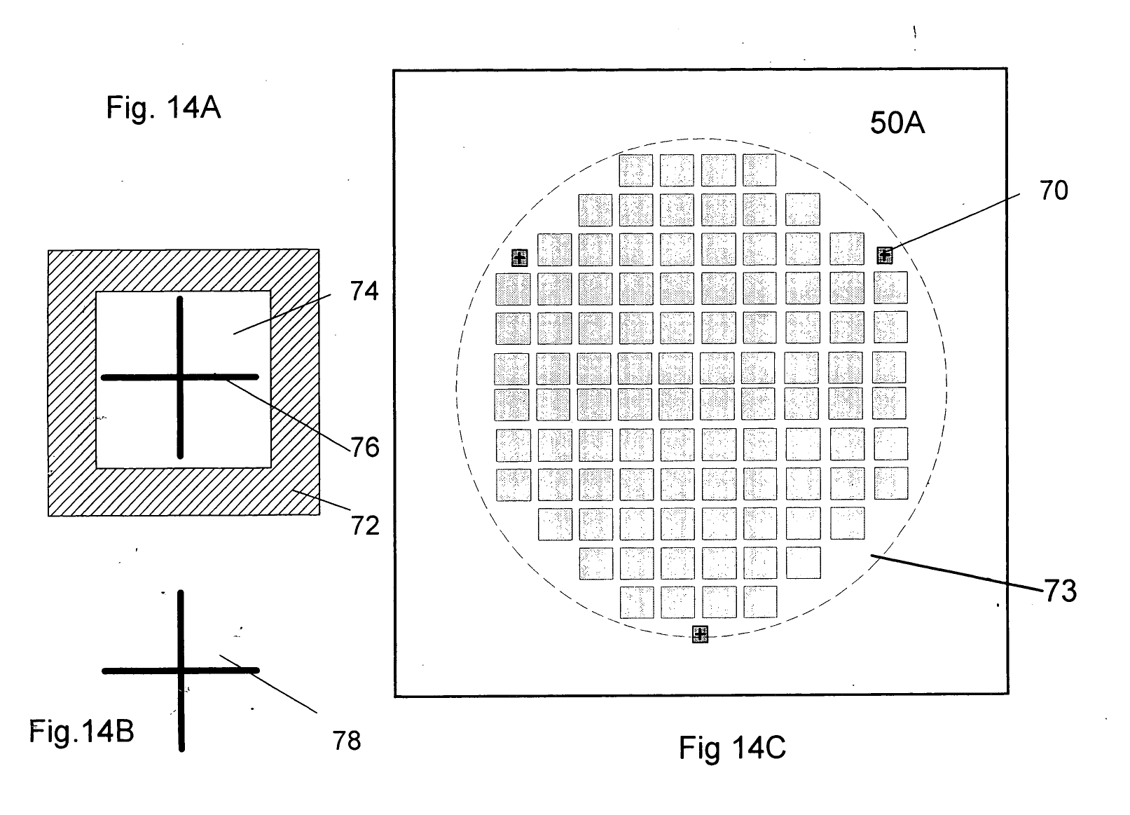

FIGS. 14A, 14B and 14C show how alignment is performed with the alternate embodiment of the moldplate 50A. Since in this case the moldplate is not transparent, alignment marks are required on the wafer 73. The location of these wafer alignment marks would corresponds to three windows 70 on the moldplate. Each window includes a clear area 74 in the blanket coating 72. Also contained in the clear area is a moldplate alignment mark 76 which is aligned to the corresponding mark 78 on the wafer 73.

### EXAMPLE

It has been found that whereas conventional glass solder transfer moldplates require substantial effort to achieve defect-free cavity densities of 0.004 inch (0.1 mm) diameter cavities on 0.008 inch (0.2 mm) centers, laser-drilled composite solder transfer moldplates have readily achieved finer 0.003 inch (0.08 mm) diameter cavities on 0.006 inch (0.15 mm) centers without defects. Thus, the extendibility of this simplified composite structure is demonstrated.

Since an important aspect of this invention deals with the cavities in the composite solder transfer moldplate structure, details of the laser machining process used to produce the cavities are provided below.

Laser drilling is performed on a ESI 5210 Laser Microvia System provided by Electo Scientific Industries, Inc. of Portland, Oreg. A frequency-tripled Nd:YAG laser operating at a wavelength of 355 nanometers is used. The pulse width of the laser is on the order of 50 nanoseconds. The output of the laser is increased in diameter and collimated by appropriate optics. The beam is positioned relative to the surface of the work piece by coordinated motion of the stage on which the sample is mounted (y-axis), the optics (x-axis), and galvomirrors (x and y axes). The position of the sample with respect to the focal plane of the laser beam (along the z-axis) can also be adjusted. The spatial distribution of energy in the circular laser spot is homogenized and beam diameter adjusted by use of supplied optics supplied by Electro Scientific Industries, Inc. In this instance, hole diameter is further varied by adjusting the relative position of the imaged beam with respect to the surface of the polyimide film. Other salient parameters are listed in Table I below. Parameters are defined as follows.

Rep Rate—is the number of laser pulses delivered to the work piece per unit time.

Power—is the average power of the laser.

Z-Offset—is the relative position of the imaged beam with respect to the surface of the polyimide film; a negative number indicates that the beam is imaged below the surface.

Pulses—indicates the number of times a laser pulse is delivered at a given hole location.

TABLE I

| | | |
|---|---|---|
| Nominal Via Diameter (microns) | 75 | 100 |
| Power (watts) | 0.4 | 0.4 |
| Z offset | −0.5 | −0.75 |
| Repetition Rate | 10 kHz | 10 kHz |
| Pulses | 100 | 120 |

The hole making rate using these conditions is 87.72 holes per second for 75 micron vias, and 74.63 holes per second for 100 micron vias. These rates can be increased by further process optimization, specifically by increasing both the laser power and the laser rep rate.

A high rate of hole drilling is desirable especially if moldplates will be used for processor wafers. Since these typically may have thousands of inputs and outputs (I/O's) per die and contain 50 or more dies per wafer, the overall number of holes which are used as solder cavities is substantial. Since 100 micron diameter vias are typical, one can calculate the time to make a moldplate having the following specifications:
Die per wafer: 50
I/O per die: 5000
Total die per wafer: 250,000

At approximately 75 holes/sec, it takes about 55 minutes of laser time to complete machining an entire moldplate. Since moldplates are reusable, the total number required for any given wafer footprint is modest, typically between ten and fifty.

One of the key benefits of using a programmable laser machining system is the avoidance of making transmission laser masks. These are precision parts that are time-consuming and costly to make and are required for each new wafer footprint. Instead, a programmable laser system only requires the data file of each footprint and is immediately ready to begin drilling the actual parts.

Depending on laser processing conditions, it may or may not be necessary to do any post laser cleaning of the moldplate. If required for certain applications, oxygen ashing may be done on the side of the moldplate containing the newly machined cavities.

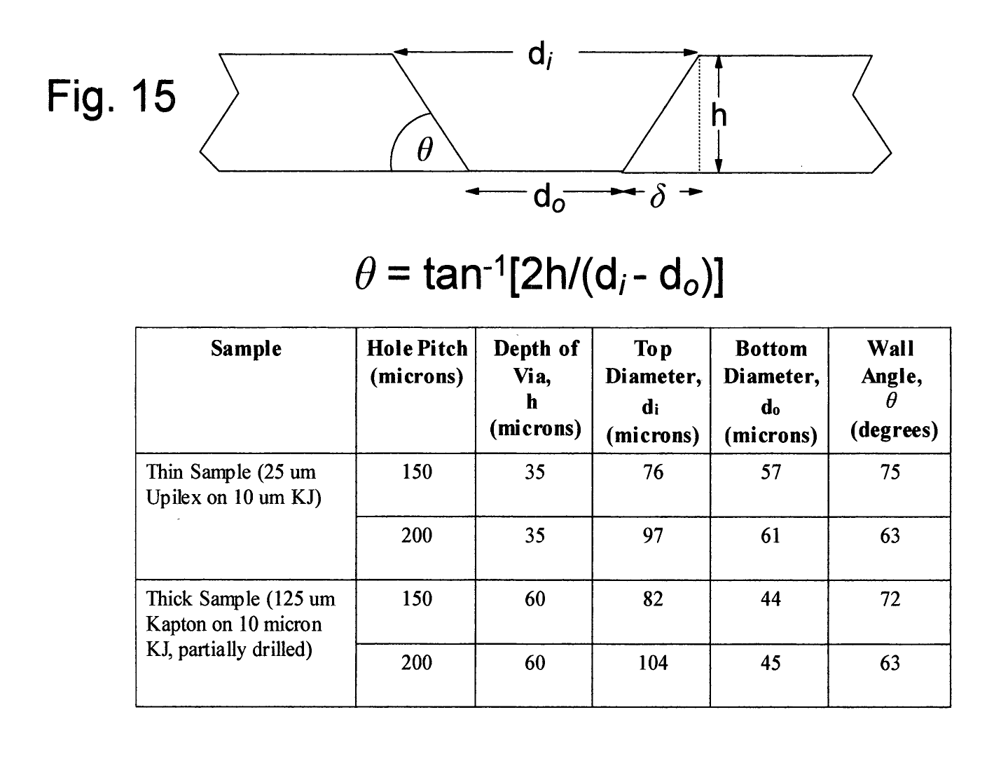

As shown in FIG. 15, the profile achieved by laser machining as described here is ideally suited for IMS bumping applications. Although various wall angles are achieved depending on polyimide type and process parameters, all are compatible with the IMS transfer process. Whereas conventional wet etching processes produce a “flattened hemisphere”, laser processing produces a shape roughly analogous to a truncated cone. This facilitates the release of the solder during the transfer operation. The only hole shape that is not acceptable for IMS is a reentrant geometry, where the top diameter is smaller than the bottom diameter of the hole. Again, as can be seen in the table in FIG. 15, this is never the case with laser machining.

The present invention method for a composite solder transfer moldplate structure has been described in detail above. Several key advantages can be achieved. First, the application process of the preferred embodiment is a simple lamination, assuring very uniform coating thickness by virtue of the sheet thickness uniformities. Secondly, through lamination on both sides of the core glass plate, CTE mismatches between glass and polyimide are canceled out, assuring that the composite moldplate structure remains relatively flat during the solder fill and transfer temperature excursions. Third, since a programmable laser machining process is used, time-consuming and expensive photomasks are not required and various designs can be quickly produced. Fourth, when aggressive solvents are used, the addition of a passivating coating on the polyimide layers will prevent any attack of the polyimide by the solvent.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to and variations of the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments have been provided as an example and not as a limitation. The scope of the invention is defined by the appended claims.

Having thus described our invention, what we claim as new and desire to secure by Letters Patent is as follows:

1. A method for constructing a composite solder transfer moldplate for flip chip wafer bumping of a substrate, comprising the steps of:
coating at least one polymer layer onto a first side of a transparent plate, the plate having a thermal expansion coefficient similar to that of the substrate; and
forming a multiplicity of cavities in a polymer layer on one side of said plate, each cavity being for receiving solder.

2. The method according to claim 1, wherein the polymer is a polyimide.

3. The method according to claim 1, wherein the plate is formed of a glass.

4. The method according to claim 1, wherein said coating does not cause significant changes in flatness of said plate.

5. The method according to claim 1, further comprising coating an additional polymer layer onto said plate on a side of said plate opposite said first side.

6. The method according to claim 1, wherein the coating is performed by at least one of spin coating and lamination.

7. The method according to claim 1, wherein the lamination comprises a micro-roughening of the surface of the plate to enhance adhesion of the polymer layer to the plate.

8. The method according to claim 1, wherein the lamination includes applying a liquid polymer between the plate and each polyimide layer to increase bond strength between the layer and the plate.

9. The method according to claim 1, further comprising passivating the polymer layer containing the multiplicity of cavities with a metal layer.

10. The method according to claim 9, wherein the metal layer is composed of a single layer selected from Cr, Mo, W, V, Ti, Nb, Hf, Cu, Ni, Co, and alloys thereof.

11. The method according to claim 9, wherein the metal layer is composed of a multilayer coating wherein metals of two adjacent layers are selected from two or more of Cr, Mo, W, V, Ti, Nb, Hf, Cu, Ni, Co, and alloys thereof.

12. The method according to claim 1, wherein the cavities in one of the polyimide layers are formed by laser machining.

13. The method according to claim 1, wherein the cavities in one of the polyimide layers are formed by maskless programmable laser machining.

14. The method according to claim 12, wherein the laser machining is performed by using a Nd:YAG laser operating at a wavelength of 355 nanometers.

15. The method according to claim 12, wherein the laser machining is performed by using a Nd:YAG laser operating at a power of 0.4 watts.

16. The method according to claim 12, wherein output of a laser used for laser machining is focused below a surface of the polymer layer.

17. The method according to claim 12, wherein output of a laser used for laser machining is provided as a series of 50 nanosecond pulses.

18. The method according to claim 12, wherein output of a laser used for laser machining is provided as a series of pulses at a repetition rate of substantially 10 kHz.

19. A moldplate structure having at least one polymer layer disposed on at least one side of a transparent plate, one said layer having a multiplicity of cavities for receiving solder.

20. The moldplate structure according to claim 19, wherein said plate is formed of a glass.

21. The moldplate structure according to claim 20, wherein the glass has a coefficient of thermal expansion matched to that of silicon.

22. The moldplate structure according to claim 20, wherein the glass is one of a borosilicate or Pyrex™.

23. The moldplate structure according to claim 19, wherein the at least one polymer layer comprises a polymer layer on each side of said plate.

24. The moldplate structure according to claim 19, wherein the at least one polymer layer comprises a polyimide.

25. The moldplate structure according to claim 13, wherein the at least one polymer layer has a thickness of between substantially 0.13 mm and substantially 0.25 mmm.

26. The moldplate structure according to claim 19, further comprising a metal layer disposed on said polymer layer.

27. The moldplate structure according to claim 26, wherein the metal layer is composed of a single layer selected from Cr, Mo, W, V, Ti, Nb, Hf, Cu, Ni, Co, and alloys thereof.

28. The moldplate structure according to claim 26, wherein the metal layer is composed of a multilayer coating wherein metals of two adjacent layers are selected from two or more of Cr, Mo, W, V, Ti, Nb, Hf, Cu, Ni, Co.
